(19) United States
(12) Patent Application Publication
(10) Pub. No.: US 2013/0169119 A1
(43) Pub. Date: Jul. 4, 2013

(54) WHEEL DRIVEN MECHANISM

(71) Applicant: YEE-PIEN YANG, TAIPEI (TW)

(72) Inventor: YEE-PIEN YANG, TAIPEI (TW)

(73) Assignee: NATIONAL TAIWAN UNIVERSITY, TAIPEI (TW)

(21) Appl. No.: 13/468,321

(22) Filed: May 10, 2012

(30) Foreign Application Priority Data
Dec. 29, 2011 (TW) 100149579

(51) Int. Cl. H02K 7/14

(52) U.S. Cl. 310/67 R

(57) ABSTRACT

A wheel driven mechanism adapted for driving a vehicle without motor is disclosed to include a rotor defining therein an accommodation chamber, a plurality of permanent magnets arranged in the accommodation chamber of the rotor, a stator having one or a number of stator segments, and one or a number of electromagnets located on the stator segment(s) within the accommodation chamber and facing toward the permanent magnets at the stator to enhance the convenience of use of the wheel driven mechanism.

### BACKGROUND OF THE INVENTION

The present invention relative to a wheel driven mechanism and more particularly to such a wheel driven mechanism specially designed for driving a vehicle without a motor.

Referring to FIG. 1, a conventional handwheel for electric wheelchair is shown. As illustrated, the handwheel 10 comprises a wheel rim 11, a plurality of brackets 14, a plurality of permanent magnets 13, and a plurality of electromagnets 16, wherein the permanent magnets 13 are arranged along the wheel rim 11, each bracket 14 has its one end connected to the axle center 17 of the wheel rim 11 and the electromagnets 16 are arranged at the other ends of the brackets 16. During operation, the user can hold and rotate the wheel rim 10. The permanent magnets 13 are arranged in NS pole pairs and evenly located on the inner surface of the wheel rim 11 to face toward the axle center 17. Further, the permanent magnets 13 of N-S poles are in alternate arrangement. As shown in FIG. 1, the permanent magnets 13 of N-S poles are evenly and alternatively arranged over the whole inner surface of the wheel rim 11 in radial direction to face toward the axle center 17 of the wheel rim 11.

The electromagnets 16 are disposed corresponding to the inner side of the wheel rim 11. During operation, power supply is provided to the electromagnets 16, causing the electromagnets 16 to create a magnetic field relative to the permanent magnets 13 of NS pole pairs. The magnetic coupling interaction between the electromagnets 16 and the permanent magnets 13 causes the wheel rim 11 to rotate relative to the axle center 17.

In FIG. 1, the electromagnets 16 are radially arranged to face toward the permanent magnets 13 at the inner side of the wheel rim 11. The electromagnets 16 are divided into two groups, namely, the first electromagnet group 121 and the second electromagnet group 123. The first electromagnet group 121 is arranged at one end of a first bracket 141, which has its other end located on the axle center 17 of the wheel rim 11. Similarly, the second electromagnet group 123 is arranged at one end of a second bracket 143, which has its other end located on the axle center 17 of the wheel rim 11. Thus, the first electromagnet group 121 and the second electromagnet group 123 are symmetric relative to the axle center 17.

Further, a gap 15 is defined between the electromagnets 16 and the permanent magnets 13 so that the wheel rim 11 carrying the permanent magnets 13 is rotatable relative to the electromagnets 16 at the brackets 14. However, when the user operates the handwheel 10, the fingers or a part of the body of the user may be jammed in the gap 15 accidentally, causing injury.

Further, after a certain period of time in use, the wheel rim 11 may be deformed, resulting in a variation of the gap 15 between the electromagnets 16 at the brackets 14 and the permanent magnets 13 at the wheel rim 11. When this condition occurs, the magnetic coupling interaction between the electromagnets 16 and the permanent magnets 13 will be changed, causing wheel rim performance drop or wheel rim damage.

Therefore, there is a strong demand for a wheel driven mechanism, which eliminates the aforesaid problems.

### SUMMARY OF THE PRESENT INVENTION

It is, therefore, an object of the present invention to provide a wheel driven mechanism, which comprises a rotor defining therein an accommodation chamber, a stator having at least one stator segment, and at least one electromagnet set arranged at the at least one stator segment in which a manner that the electromagnet set and/or the stator segment is disposed in the accommodation chamber, preventing jammed fingers during operation.

It is another object of the present invention to provide a wheel driven mechanism, which further comprises a bearing arranged between the rotor and the stator to maintain the gap between the permanent magnets at the stator and the electromagnet set at the stator during relative motion between the rotor and the stator, facilitating smooth relative motion between the rotor and the stator.

It is still another object of the present invention to provide a wheel driven mechanism, which further comprises at least one adjustment unit arranged between the stator segment and the bracket of the stator to maintain the relative positioning between the permanent magnets at the rotor and the electromagnet set at the stator segment, assuring high reliability of the operation performance of the wheel driven mechanism.

It is still another object of the present invention to provide a wheel driven mechanism, which further comprises at least one waterproof gasket arranged between the rotor and the stator to protect the accommodation chamber of the rotor against outside moisture, avoiding contact between the outside moisture and the electromagnet set and/or the permanent magnets in the accommodation chamber and prolonging the working life of the wheel driven mechanism.

To achieve these and other objects of the present invention, the present invention provides a wheel driven mechanism, comprising: a rotor defining therein an accommodation chamber; a plurality of permanent magnets mounted inside the accommodation chamber of the rotor; a stator comprising at least one stator segment; and at least one electromagnet set arranged at the stator segment and disposed inside the accommodation chamber of the rotor and facing toward the permanent magnets.

In one embodiment of aforesaid wheel driven mechanism, further comprises a gap defined between the permanent magnets at the rotor and the electromagnet set at the stator segment.

In one embodiment of aforesaid wheel driven mechanism, further comprises at least one bearing set between the rotor and the at least one stator segment.

In one embodiment of aforesaid wheel driven mechanism, wherein the stator comprises a bracket, and the stator segment is located on the bracket.

In one embodiment of aforesaid wheel driven mechanism, further comprises at least one adjustment unit set between the bracket and the stator segment and controllable to adjust the relative positioning between the electromagnet set at the stator segment and the permanent magnets at the rotor.

In one embodiment of aforesaid wheel driven mechanism, further comprises at least one waterproof gasket set between the rotor and the stator to watertightly seal the accommodation chamber into an enclosed space.

In one embodiment of aforesaid wheel driven mechanism, further comprises a drainage passage set between the rotor and the stator.

In one embodiment of aforesaid wheel driven mechanism, wherein the drainage passage is disposed between the waterproof gasket and the stator.

In one embodiment of aforesaid wheel driven mechanism, wherein each the electromagnet set comprises at least one coil and at least one magnetic flux conducting unit, the at least one coil being respectively wound on the at least one magnetic flux conducting unit.

In one embodiment of aforesaid wheel driven mechanism, wherein the rotor is an annular member, and the accommodation chamber is an annular chamber defined in the rotor.

In one embodiment of aforesaid wheel driven mechanism, wherein the rotor is a tube handwheel of a wheelchair.

In one embodiment of aforesaid wheel driven mechanism, wherein the rotor is a driving wheel of a vehicle.

### BRIEF DESCRIPTION OF THE DRAWINGS

FIG. 1 is a schematic drawing illustrating the structure of a handwheel of a conventional electric wheelchair.

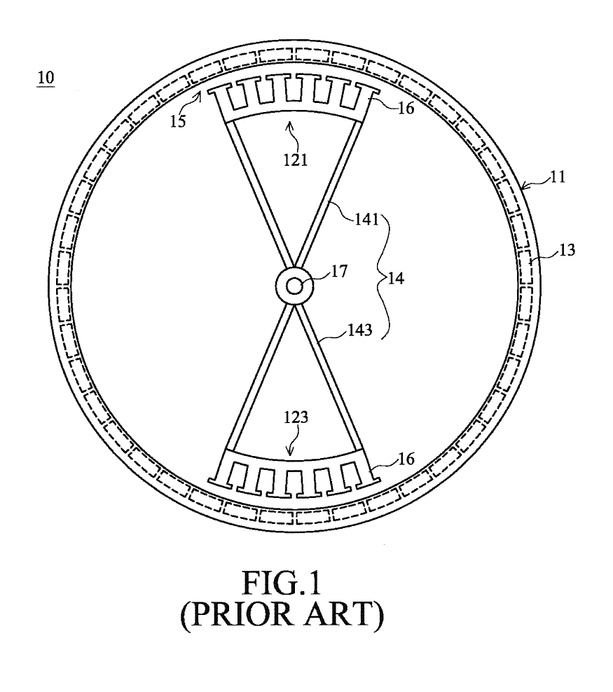

FIG. 2 is a schematic perspective front view of a wheel driven mechanism in accordance with a first embodiment of the present invention.

FIG. 3 is a schematic sectional view of the wheel driven mechanism in accordance with the first embodiment of the present invention.

FIG. 4 is a schematic sectional view of a wheel driven mechanism in accordance with a second embodiment of the present invention.

FIG. 5 is a schematic perspective front view of a wheel driven mechanism in accordance with a third embodiment of the present invention.

FIG. 6 is a schematic sectional view of the wheel driven mechanism in accordance with the third embodiment of the present invention.

FIG. 7 is a schematic sectional view of a wheel driven mechanism in accordance with a fourth embodiment of the present invention, illustrating, a waterproof gasket and a drainage passage provided between a rotor and a stator.

FIG. 8 is a schematic perspective front view of a wheel driven mechanism in accordance with a fifth embodiment of the present invention, illustrating a configuration of one stator segment and one electromagnet set.

FIG. 9 is a schematic perspective front view of a wheel driven mechanism in accordance with a sixth embodiment of the present invention, illustrating a configuration of three stator segments and three electromagnet sets.

### DETAILED DESCRIPTION OF THE PREFERRED EMBODIMENTS

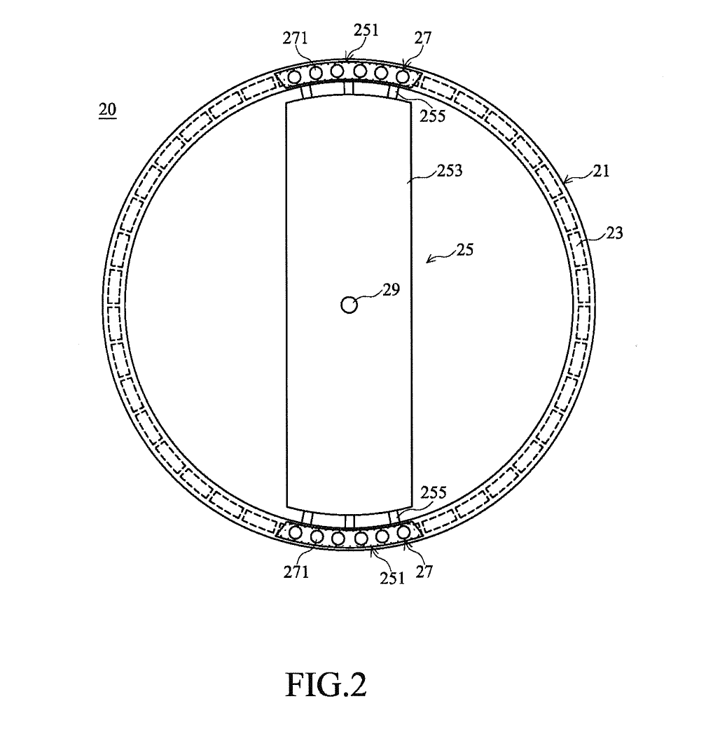

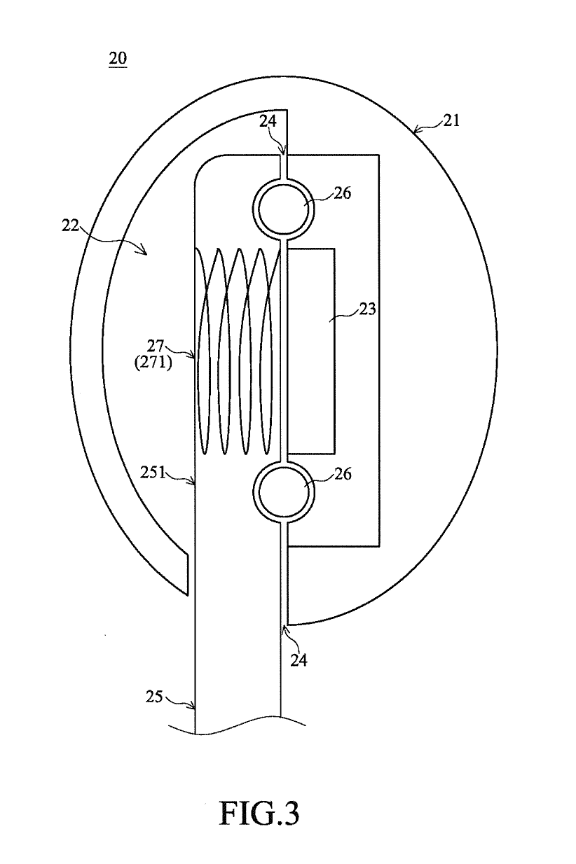

Please referring to FIGS. 2 and 3, a schematic perspective front view and a schematic sectional view of a wheel driven mechanism in accordance with a first embodiment of the present invention are shown. As illustrated, the wheel driven mechanism 20 comprises a rotor 21, a plurality of permanent magnets 23, and a stator 25. The stator 25 comprises at least one stator segment 251 and at least one bracket 253. The stator segment 251 is supported on the bracket 253. The stator segment 251 holds at least one electromagnet set 27. The electromagnet set 27 at the stator segment 251 corresponds to the permanent magnets 23 at the rotor 21. A gap 24 is defined between the electromagnet set 27 at the stator segment 251 and the permanent magnets 23 at the rotor 21 so that the rotor 21 is rotatable relative to the stator 25.

The rotor 21 defines therein an accommodation chamber 22. In this embodiment, the rotor 21 is an annular member so that the accommodation chamber 22 has an annular profile. The stator segment 251 and the electromagnet set 27 are accommodated in the accommodation chamber 22 in such a manner that the electromagnet set 27 at the stator segment 251 faces toward the permanent magnets 23 at the rotor 21. Further, the electromagnet set 27 at the stator segment 251 is periodically in a magnetic flux coupling relationship with the permanent magnets 23 at the rotor 21.

The permanent magnets 23 in this embodiment are arranged in the accommodation chamber 22 of the rotor 21 in NS pole pairs over the whole or a part of the inner surface of the rotor 21. Further, the N or S pole of each permanent magnet 23 is disposed in axial direction. Further, the permanent magnets 23 of N-S poles are in alternate arrangement.

The bracket 253 of the stator 25 is fixedly mounted at the axle center 29 of the wheel driven mechanism 20. Each of the two opposite ends of each bracket 253 has stator segment 251 arranged thereon. Each stator segment 251 carries electromagnet set 27. Thus, the electromagnet set 27 and/or the stator segment 251 is arranged in a symmetrical manner relative to the axle center 29. Further, each electromagnet set 27 comprises a plurality of, for example, 6 electromagnets 271.

In actual application, if a three-phase power supply is to be provided to the wheel driven mechanism 20, the number of the electromagnets 271 of the electromagnet set 27 should be a multiple of 3, for example, 3, 6, 9, etc. If a two-phase power supply is to be provided to the wheel driven mechanism 20, the number of the electromagnets 271 of the electromagnet set 27 should be a multiple of 2, for example, 2, 4, 6, etc.

The electromagnets 271 of each electromagnet set 27 are made from coils. When electrically conducted, the electromagnets 271 of each electromagnet set 27 create a magnetic field. In different embodiments, coils can be wound around a magnetic flux conducting unit, for example, a cylindrical magnetic flux conducting core prepared by ferrite (Fe), cobalt (Co) or nickel (Ni), for creating a high strength of magnetic field to enhance the torque of the wheel driven mechanism 20.

According to the present invention, the electromagnet set 27 and/or the stator segment 251 is accommodated in the accommodation chamber 22 of the rotor 21 so that the gap 24 between the stator 25 and the rotor 21 will not be apparently exposed to the external structure of the wheel driven mechanism 20, preventing the user's fingers from being jammed between the stator 25 and the rotor 21 during operation and increasing the level of safety of the use of the wheel driven mechanism 20.

To enhance the efficiency of the wheel driven mechanism 20, at least one bearing 26 may be set between the stator segment 251 of the stator 25 and the rotor 21. The bearing 26 each can be a ball bearing or needle bearing. In actual application, the bearing 26 can be arranged at the stator segment 251 of the stator 25 or the rotor 21. Subject to the arrangement of the bearing 26, the gap 24 between the permanent magnets 23 at the rotor 21 and the electromagnet set 27 at the stator segment 251 of the stator 25 is maintained during relative motion between the rotor 21 and the stator 25, facilitating smooth relative motion between the rotor 21 and the stator 25.

In this first embodiment, the bracket 253 is adjustably connected to the stator segment 251 by at least one adjustment unit 255. By means of the adjustment unit 255, the user can adjust the relative positioning between the electromagnet set 27 at the stator segment 251 of the stator 25 and the bracket 253 to compensate the amount of deformation of the roundness of the wheel driven mechanism 20. The adjustment unit 255 has a deformation characteristic. For example, each adjustment unit 255 can be a spring member or sliding block.

Normally, the wheel driven mechanism 20 may deform due to uneven external pressure after a certain period of time in use, resulting in non-roundness of the rotor 21. Following shape change of the rotor 21, the overlapped area between the electromagnet set 27 at the stator segment 251 and the permanent magnets 23 at the stator 21 may be contracted, affecting the performance of the wheel driven mechanism 20.

Subject to the use of the adjustment unit 255 and/or the bearing 26, the relative positioning between the permanent magnets 23 at the rotor 21 and the electromagnet set 27 at the stator segment 251 of the stator 25 is constantly maintained unchanged, avoiding deformation of the rotor 21 or affecting the operation performance of the wheel driven mechanism 20.

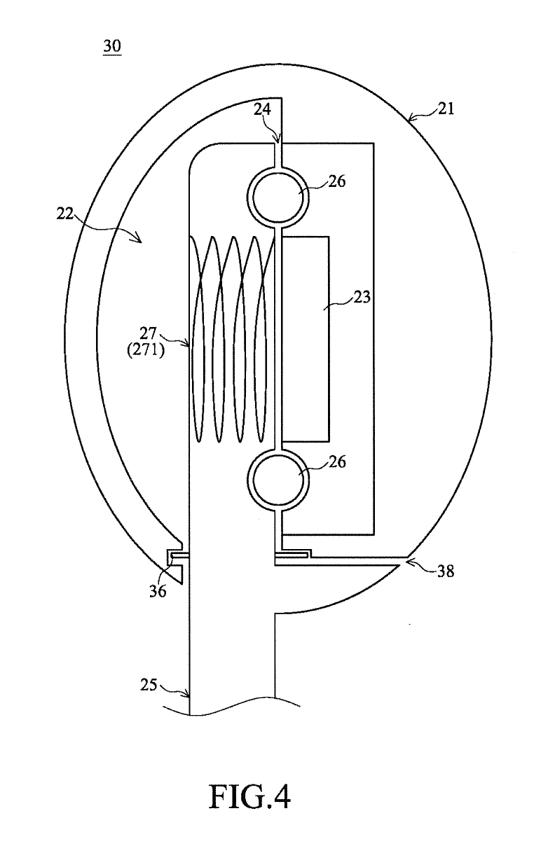

Referring to FIG. 4, a wheel driven mechanism in accordance with a second embodiment of the present invention is shown. As illustrated, the wheel driven mechanism 30 comprises a rotor 21, a plurality of permanent magnets 23, a stator 25 comprising at least one stator segment 251, and at least one electromagnet set 27 installed in the stator segment 251 of the stator 25. Further, the electromagnet set 27 comprises a plurality of electromagnets 271. The rotor 21 defines therein an accommodation chamber 22. The electromagnet set 27 and/or the stator segment 251 of the stator 25 is accommodated in the accommodation chamber 22 of the rotor 21. The electromagnet set 27 faces toward the permanent magnets 23 with a gap 24 left therebetween so that the rotor 21 is rotatable relative to the stator 25.

In this embodiment, the wheel driven mechanism 30 further comprises a waterproof gasket 36 set between the rotor 21 and the stator 25. The waterproof gasket 36 can be mounted at the rotor 21 or stator 25 to watertightly seal the accommodation chamber 22 of the rotor 21, avoiding permeation of external moisture into the accommodation chamber 22 to wet the at least one electromagnet set 27 in the accommodation chamber 22.

The wheel driven mechanism 30 further comprises a drainage passage 38 disposed between the rotor 21 and the stator 25 for expelling water out of the accommodation chamber 22 by means of a centrifugal force generated during the rotation of the rotor 21. The drainage passage 38 can be set between the waterproof gasket 36 and stator 25 so that a part of moisture can be guided by the drainage passage 38 to the outside of the accommodation chamber 22 before touching the waterproof gasket 36, lowering the chance of moisture intrusion into the accommodation chamber 22. Further, the internal air pressure in the rotor 21 will become higher than the external air pressure to lower the chance of moisture intrusion into the accommodation chamber 22 upon a rise in temperature in the accommodation chamber 22 due to conduction of an electric current through the electromagnets 271.

As the electromagnets 271 and the permanent magnets 23 are mainly prepared by ferrite (Fe), cobalt (Co) or nickel (Ni), the electromagnets 271 or the permanent magnets 23 may be rusted or damaged when putting into contact with moisture for a long period of time. By means of the arrangement of the waterproof gasket 36 and/or the drainage passage 38, the electromagnets 271 and the permanent magnets 23 are isolated from external moisture, effectively prolonging the working life of the wheel driven mechanism 30.

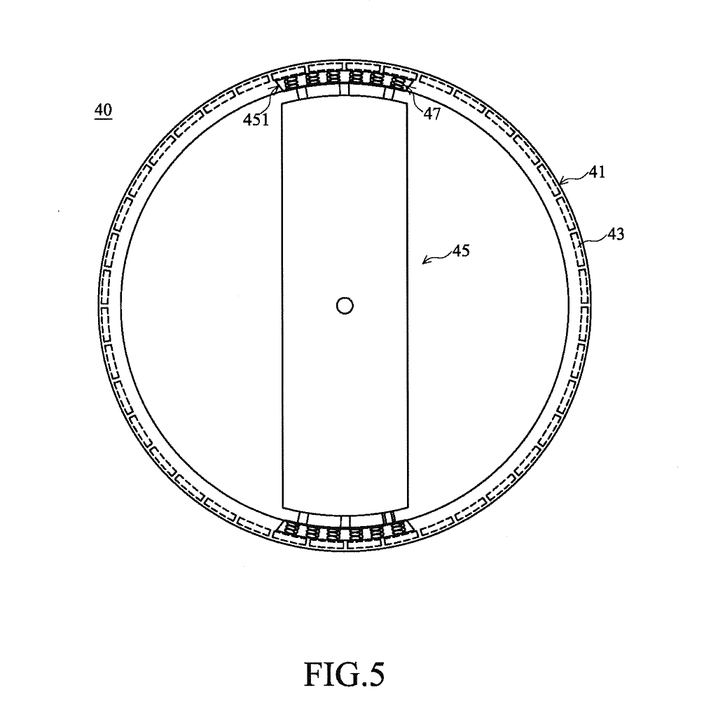

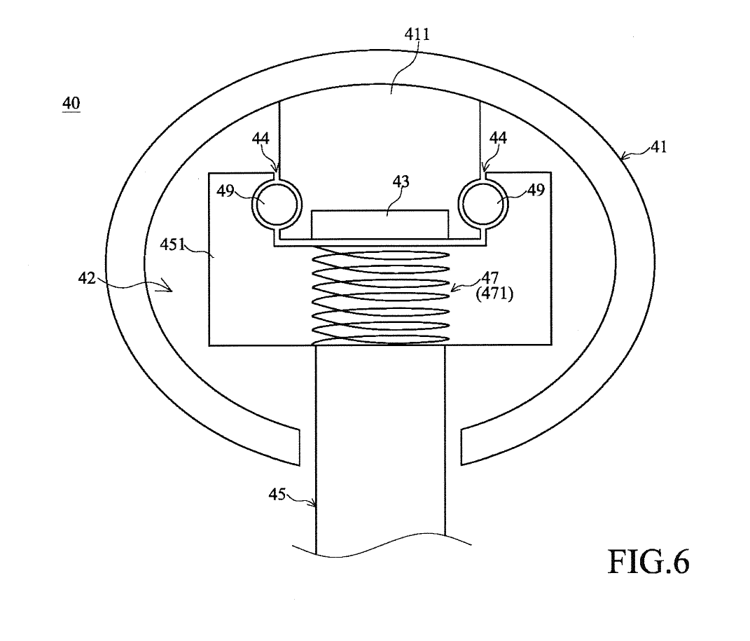

Please referring to FIG. 5 and FIG. 6, a schematic perspective front view and a schematic sectional view of the wheel driven mechanism in accordance with a third embodiment of the present invention. As illustrated, the wheel driven mechanism 40 comprises a rotor 41, a plurality of permanent magnets 43, a stator 45 comprising at least one stator segment 451, and at least one electromagnet set 47 comprising a plurality of electromagnets 471 arranged at the at least one stator segment 451. The rotor 41 defines therein an accommodation chamber 42. The electromagnet set 47 and/or the stator segment 451 is accommodated in the accommodation chamber 42 of the rotor 41. Further, the electromagnet set 47 faces toward the permanent magnets 43 in the accommodation chamber 42 with a gap 44 left therebetween so that the rotor 41 is rotatable relative to the stator 45.

In this embodiment, the rotor 41 comprises a bracket 411, and the permanent magnets 43 are mounted at the bracket 411. The stator segment 451 is configured to surround the permanent magnets 43, keeping the electromagnet set 47 at stator segment 451 to face toward the permanent magnets 43 at the bracket 411. For example, the stator segment 451 can be configured to have a U-shaped profile for surrounding the permanent magnets 43 at the bracket 411.

Further, the U-shaped stator segment 451 can be arranged to surround a part of the bracket 411 with at least one bearing 49 set between the stator segment 451 and the bracket 411, enhancing the relative positioning stability between the permanent magnets 43 and the electromagnet set 47 and the operation performance of the wheel driven mechanism 40.

Further, the permanent magnets 43 in this embodiment are arranged in NS pole pairs. Further, the N or S pole of each permanent magnet 43 is disposed in radial direction.

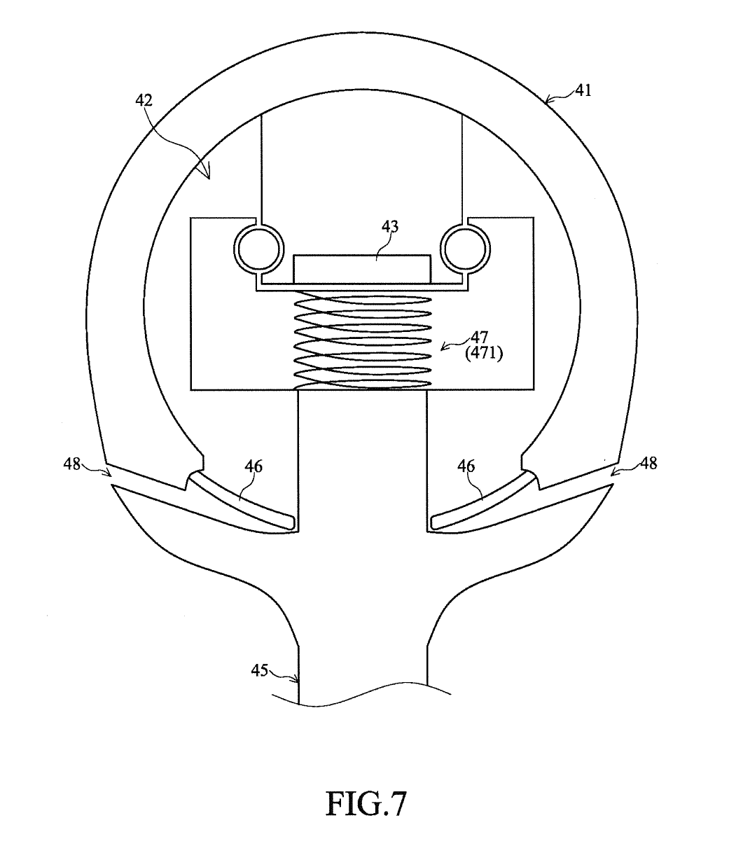

In actual application, a waterproof gasket 46 and/or a drainage passage 48 can be provided between the rotor 41 and the stator 45, as shown in FIG. 7, keeping the accommodation chamber 42 of the rotor 41 in an enclosed condition to lower the chance of moisture intrusion into the accommodation chamber 42. Further, the internal air pressure in the rotor 41 will become higher than the external air pressure to lower the chance of moisture intrusion into the accommodation chamber 42 and to prolong the working life of the wheel driven mechanism 40 upon a rise in temperature in the accommodation chamber 42 due to conduction of an electric current through the electromagnets 471.

Further, the winding condition of the electromagnet sets 27/47 and the relative arrangement of the permanent magnets 23/43 enables the air gap flux to be axially or radially direction. For example, the air gap flux of electromagnet sets 27 and permanent magnets 23 of the wheel driven mechanism 20/30 in FIG. 3 and FIG. 4 are axially directed where the windings of the electromagnet sets 27 extend in a parallel manner relative to the wheel driven mechanism 20/30, and the axle center of the rotor 21 and/or stator 25. The air gap flux of electromagnet sets 47 and permanent magnets 43 of the wheel driven mechanism 40 in FIGS. 5-7 are radially directed where the windings of the electromagnet sets 47 extend along the radius direction of the wheel driven mechanism 40, rotor 41 and/or stator 45. The aforesaid two winding methods can be selectively used to make the wheel driven mechanism subject to actual requirements.

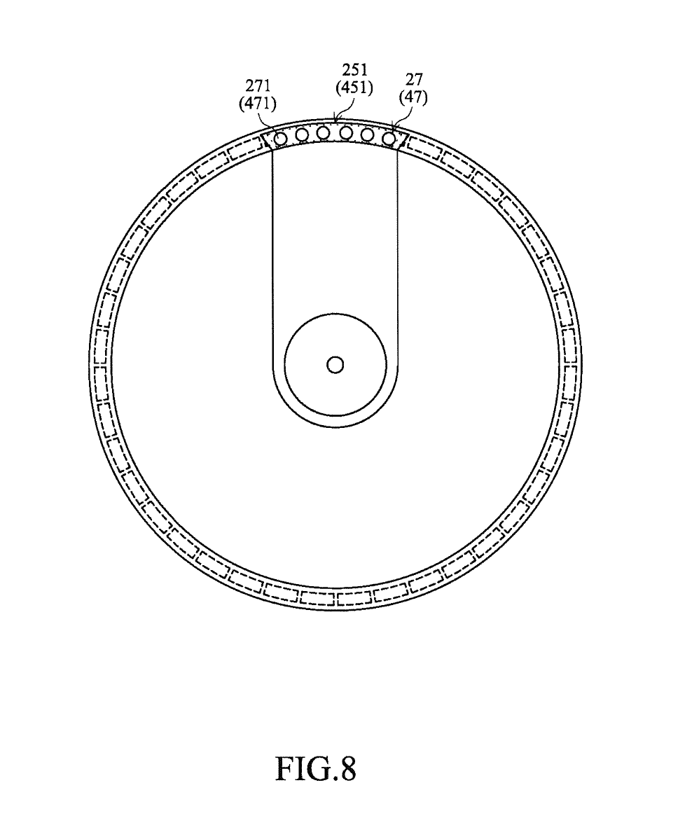

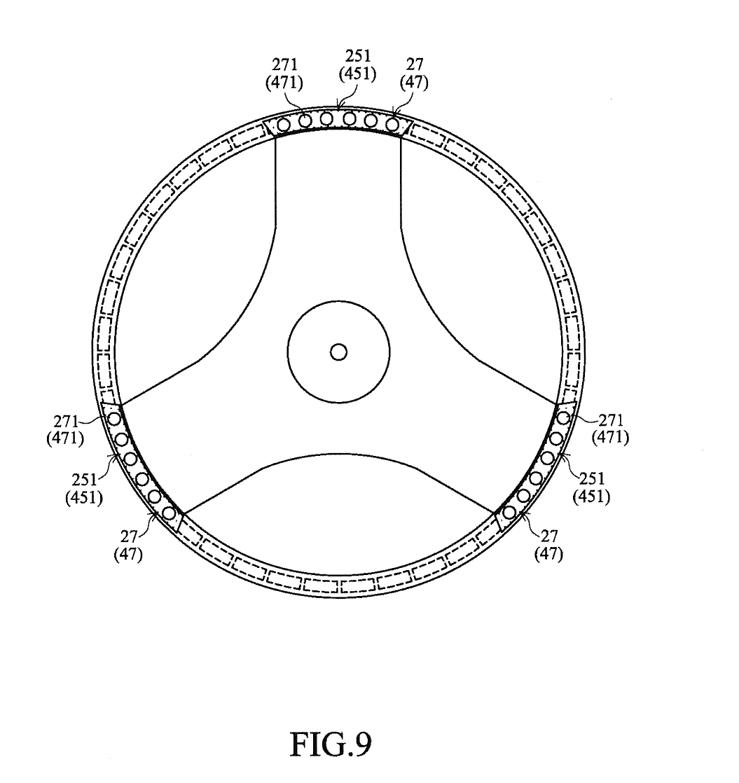

In the aforesaid various embodiments, the wheel driven mechanism 20/30/40 mainly comprises two stator segments 251/451 and two electromagnet sets 27/47 respectively located on the two ends of the bracket 253. However, in the embodiment shown in FIG. 8, only one stator segment 251/451 and one electromagnet set 27/47 are provided. Further, the number of the stator segments 251/451 and the number of the electromagnet sets 27/47 can be more than 2. For example, in the embodiment shown in FIG. 9, the wheel driven mechanism comprises three stator segments 251/451 and three electromagnet sets 27/47.

The aforesaid wheel driven mechanisms 20/30/40 are designed for driving a vehicle, for example, a wheelchair, electric bicycle, motorcycle, etc., wherein the rotor 21/41 can be the driving wheel of a vehicle or the tube handwheel of a wheelchair.

What is claimed is:

1. A wheel driven mechanism, comprising:
a rotor defining therein an accommodation chamber;
a plurality of permanent magnets mounted inside said accommodation chamber of said rotor;
a stator comprising at least one stator segment; and
at least one electromagnet set arranged at said stator segment and disposed inside said accommodation chamber of said rotor and facing toward said permanent magnets.

2. The wheel driven mechanism as recited in claim 1, further comprising a gap defined between said permanent magnets at said rotor and said electromagnet set at said stator segment.

3. The wheel driven mechanism as recited in claim 2, further comprising at least one bearing set between said rotor and said at least one stator segment.

4. The wheel driven mechanism as recited in claim 1, wherein said stator comprises a bracket, and said stator segment is located on said bracket.

5. The wheel driven mechanism as recited in claim 2, wherein said stator comprises a bracket, and said stator segment is located on said bracket.

6. The wheel driven mechanism as recited in claim 3, wherein said stator comprises a bracket, and said stator segment is located on said bracket.

7. The wheel driven mechanism as recited in claim 4, further comprising at least one adjustment unit set between said bracket and said stator segment and controllable to adjust the relative positioning between said electromagnet set at said stator segment and said permanent magnets at said rotor.

8. The wheel driven mechanism as recited in claim 5, further comprising at least one adjustment unit set between said bracket and said stator segment and controllable to adjust the relative positioning between said electromagnet set at said stator segment and said permanent magnets at said rotor.

9. The wheel driven mechanism as recited in claim 6, further comprising at least one adjustment unit set between said bracket and said stator segment and controllable to adjust the relative positioning between said electromagnet set at said stator segment and said permanent magnets at said rotor.

10. The wheel driven mechanism as recited in claim 1, further comprising at least one waterproof gasket set between said rotor and said stator to watertightly seal said accommodation chamber into an enclosed space.

11. The wheel driven mechanism as recited in claim 2, further comprising at least one waterproof gasket set between said rotor and said stator to watertightly seal said accommodation chamber into an enclosed space.

12. The wheel driven mechanism as recited in claim 3, further comprising at least one waterproof gasket set between said rotor and said stator to watertightly seal said accommodation chamber into an enclosed space.

13. The wheel driven mechanism as recited in claim 10, further comprising a drainage passage set between said rotor and said stator.

14. The wheel driven mechanism as recited in claim 11, further comprising a drainage passage set between said rotor and said stator.

15. The wheel driven mechanism as recited in claim 12, further comprising a drainage passage set between said rotor and said stator.

16. The wheel driven mechanism as recited in claim 13, wherein said drainage passage is disposed between said waterproof gasket and said stator.

17. The wheel driven mechanism as recited in claim 14, wherein said drainage passage is disposed between said waterproof gasket and said stator.

18. The wheel driven mechanism as recited in claim 15, wherein said drainage passage is disposed between said waterproof gasket and said stator.

19. The wheel driven mechanism as recited in claim 1, wherein each said electromagnet set comprises at least one coil and at least one magnetic flux conducting unit, said at least one coil being respectively wound on said at least one magnetic flux conducting unit.

20. The wheel driven mechanism as recited in claim 2, wherein each said electromagnet set comprises at least one coil and at least one magnetic flux conducting unit, said at least one coil being respectively wound on said at least one magnetic flux conducting unit.

21. The wheel driven mechanism as recited in claim 3, wherein each said electromagnet set comprises at least one coil and at least one magnetic flux conducting unit, said at least one coil being respectively wound on said at least one magnetic flux conducting unit.

22. The wheel driven mechanism as recited in claim 1, wherein said rotor is an annular member, and said accommodation chamber is an annular chamber defined in said rotor.

23. The wheel driven mechanism as recited in claim 2, wherein said rotor is an annular member, and said accommodation chamber is an annular chamber defined in said rotor.

24. The wheel driven mechanism as recited in claim 3, wherein said rotor is an annular member, and said accommodation chamber is an annular chamber defined in said rotor.

25. The wheel driven mechanism as recited in claim 1, wherein said rotor is a tube handwheel of a wheelchair.

26. The wheel driven mechanism as recited in claim 2, wherein said rotor is a tube handwheel of a wheelchair.

27. The wheel driven mechanism as recited in claim 3, wherein said rotor is a tube handwheel of a wheelchair.

28. The wheel driven mechanism as recited in claim 1, wherein said rotor is a driving wheel of a vehicle.

29. The wheel driven mechanism as recited in claim 2, wherein said rotor is a driving wheel of a vehicle.

30. The wheel driven mechanism as recited in claim 3, wherein said rotor is a driving wheel of a vehicle.
